(19) United States
(12) Patent Application Publication
(10) Pub. No.: US 2014/0181940 A1
(43) Pub. Date: Jun. 26, 2014

(54) FILE MANAGEMENT METHOD AND SYSTEM AND STORAGE MEDIUMS

(71) Applicant: Tencent Technology (Shenzhen) Company Limited, Shenzhen City (CN)

(72) Inventor: Bingbing WU, Shenzhen City (CN)

(73) Assignee: Tencent Technology (Shenzhen) Company Limited, Shenzhen City (CN)

(21) Appl. No.: 14/109,982

(22) Filed: Dec. 18, 2013

Related U.S. Application Data
(63) Continuation of application No. PCT/CN2012/077629, filed on Jun. 27, 2012.

(30) Foreign Application Priority Data
Oct. 13, 2011 (CN) 201110310211.1

(51) Int. Cl. H04L 29/08; H04L 29/06

(52) U.S. Cl. CPC H04L 67/06; H04L 63/08
USPC 726/7; 709/219

(57) ABSTRACT

The invention provides a file management method includes the steps of: setting cloud copy buttons in right-click menus of files and/or file folders; acquiring clicking operations on the cloud copy buttons by a user; uploading files and/or file folders selected by the user onto a server in accordance with the clicking operations. With the above method, file management becomes more convenient. Furthermore, a tile management system and storage mediums are provided.

### CROSS REFERENCE TO RELATED APPLICATIONS

This application is a continuation application of PCT Application PCT/CN2012/077629 filed on Jun. 27, 2012 claiming a priority from Chinese Application No. 201110310211.1 filed on Oct. 13, 2011. The aforementioned patent applications are hereby incorporated by reference in their entirety.

### FIELD OF THE INVENTION

The invention relates to the field of computer, and in particular, to a file management method and system and storage mediums.

### BACKGROUND

With the rapid development of computer and Internet technologies, a user often wishes to manage his own files by using a network, in addition to managing his own files by using a computer. In a traditional method of managing files by using a network, the user usually logins in a client or a network station to upload files onto a server via the client or the network station in order for integrated storage and management of the files. However, in the traditional method of managing files, it is necessary to set an entrance for uploading files on the client or the network station, and the user is required to open the entrance to select files to be uploaded and then click “Acknowledge” button to upload the files. Therefore, the traditional method of managing files is inconvenient for the user to operate.

### SUMMARY OF THE INVENTION

In view of this, it is necessary to provide a file management method capable of making user operations more convenient.

The file management method includes the steps of: acquiring clicking operations on cloud copy buttons set in right-click menus of files or file folders; invoking file-sending commands corresponding to the cloud copy buttons in accordance with the clicking operations; executing the file-sending commands to upload the files and/or file folders selected by a user onto a server.

Furthermore, it is necessary to provide a file management system capable of making user operations more convenient.

The file management system includes: an operation acquiring module for acquiring clicking operations on cloud copy buttons set in right-click menus of files or file folders; an operation processing module for invoking file-sending commands corresponding to the cloud copy buttons in accordance with the clicking operations; a file uploading module for executing the file-sending commands to upload the files and/or file folders selected by a user to a server.

Furthermore, one or more storage mediums containing computer executable instructions for implementing the above file management method are provided.

In the above file management method and system, by setting the cloud copy buttons in the right-click menus of the file and/or file folders, the user can directly click the cloud copy button in the right-click menu of a file or a file folder when selecting the file/file folder; when the clicking operation on the cloud copy button by the user is acquired, the file-sending command corresponding to the cloud copy button can be invoked and executed and the files and/or file folders selected by the user can be directly uploaded onto the server. In such a way, it is unnecessary to set the entrance for file uploading on the client or the network station, and the user is not required to select files to be uploaded via the client or the network station. So user operations are saved and it is more convenient for the user to manage files via the network.

### DESCRIPTION OF THE DRAWINGS

FIG. 1 is a diagram of a file management method in accordance with an embodiment of the invention;

FIG. 2 is a diagram of setting a cloud copy button in accordance with an embodiment of the invention;

FIG. 3 is a structural diagram of a file management system in accordance with an embodiment of the invention;

FIG. 4 is a structural diagram of a file management system in accordance with another embodiment of the invention.

### DETAILED DESCRIPTION

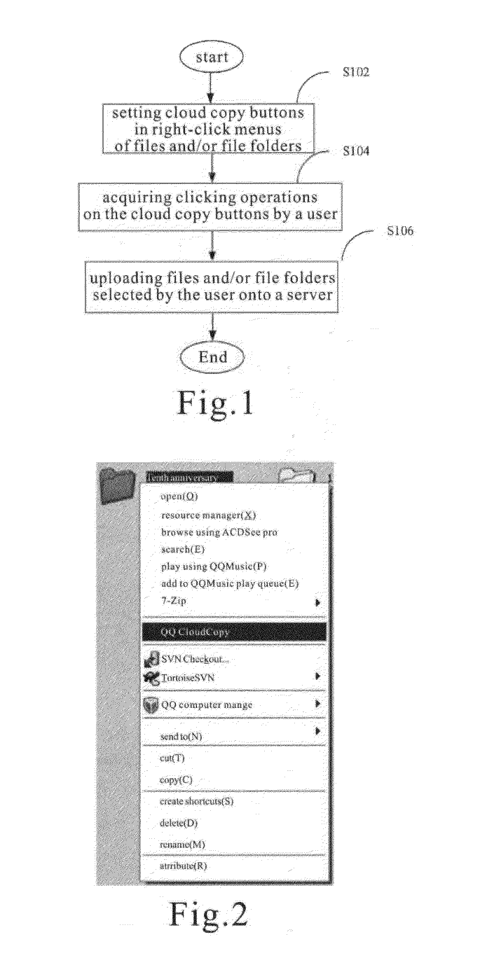

As shown in FIG. 1, in an embodiment, a file management method includes the following steps:

Step S102, setting cloud copy buttons in right-click menus of files and/or file folders.

In an embodiment, a cloud copy button can be set in the right-click menu of a file and/or a file folder by amending a corresponding sub-key in a registry. Specifically, the sub-key corresponding to the cloud copy button can be created in the registry, and a command corresponding to the sub-key can be set as a file-sending command of a preset client.

For example, a “QQCloudCopy” button will be displayed in the right-click menu of the file or the file folder by running “regedit”, opening a registry editor, addressing to “HKEY_LOCAL_MACHINE\Software\CLASSES\Directory\shell”, creating a sub-key named “QQCloudCopy” under the address, double-clicking “Default” button in a right window, and setting the value as “QQCloudCopy” in an operating system. As shown in FIG. 2, the “QQCloudCopy” button is located at a middle location of the right-click menu of the file/file folder.

Furthermore, a command corresponding to the sub-key of “QQCloudCopy” can be set. Specifically, a sub-item is created under the sub-key of “QQCloudCopy” and is named as “command”. A “Default” button in the right window is double clicked, and the value of the sub-item of “command” is set as the file-sending command of the preset client. For example, the file-sending command is “C:\Program Files\Tencent\QQpcmgr\QQpcmgr.exe”/copy“%1”)”.

As the cloud copy button corresponds to the file-sending command of the preset client, the file-sending command is executed when the cloud copy button is clicked. For example, the selected file/file folder is uploaded onto the server via the preset client when the cloud copy button is clicked.

Step S104, acquiring clicking operations on the cloud copy buttons by a user.

In an embodiment, as shown in FIG. 2, when the user selects a file or a file folder, opens the right-click menu and clicks the cloud copy button in the right-click menu, the clicking operation on the cloud copy button by the user is acquired.

Step S106, uploading files and/or file folders selected by the user onto a server.

Specifically, in the step S106, the file-sending commands corresponding to the cloud copy buttons are invoked by the clicking operations, the file-sending commands are executed, and the files and/or file folders selected by the user are uploaded onto the server.

In an embodiment, the file-sending commands of the preset client can be executed, and the files and/or file folders selected by the user can be uploaded onto the server by using a network communication protocol via a client invoking procedure. Furthermore, the files and/or file folders selected by the user can be uploaded onto the server by using “http” protocol in the manner of “post”.

The preset client can be an Instant Messaging client, a Computer Keeper client, or any other application client capable of uploading files. As described above, the value of “command” is preset as the file-sending command of a client, and the file-sending command is executed after the clicking operation on the cloud copy button is acquired, and the file and/the file folder selected by the user can be uploaded onto the server from the client.

In an embodiment, the above file management method further includes: acquiring a user identifier and file identifiers of selected files or file folders by the client, and correspondingly sending the user identifier and the file identifiers to the server.

Furthermore, the step of acquiring the user identifier by the client includes: acquiring user login information by the client; if the user login information is acquired, then acquiring the user identifier in accordance with the user login information; if the user login information is not acquired, then popping out a login block, acquiring the input user login information by the login block, and acquiring the user identifier in accordance with the input user login information.

The user identifier can be an account number for login in the client by the user, a number for uniquely identifying the user assigned for the user by the client, and so on. If the client cannot acquire the user identifier of the user currently logining in the client, it means that the current user does not login in the client, and the user identifier can be acquired after the user is reminded of logining in the client.

Furthermore, the file identifiers include file names, file sizes, file Hash values and so on. The server can store the received user identifier in association with its corresponding file identifiers. For a same user identifier, multiple file identifiers corresponding to the user identifier can be stored in association with the user identifier in the server, so that files and/or file folders uploaded by a user can be effectively managed.

Furthermore, the uploaded files can be stored in the manner of cloud storage. That is, the uploaded files can be stored by using cluster applications, grid technology, or scattered file systems. Many different kinds of storage devices in a network can assemble together and cooperate by means of application software, to jointly provide data storage and service access functions to external.

In an embodiment, before the files and/or file folders selected by the user are uploaded onto the server, the files can be verified in accordance with file Hash values to determine whether there are corresponding files in the server. If there are corresponding files in the server, it is unnecessary to upload the files already existing in the server, and reminder information that reminds the user of the existence of the files is returned.

In another embodiment, the above file management method further includes: the server acquiring the user identifier submitted by the client, acquiring the file identifiers that are associated with the user identifier; and issuing a file list corresponding to the acquired file identifiers to the client. In the embodiment, after the files are successfully uploaded, the files corresponding to the user identifier can be downloaded from the server in accordance with the user identifier, and thus file sharing is implemented.

Specifically, the user identifier can be submitted to the server by the client. The server acquires the file identifiers associated with the user identifier, forms a list by using the acquired files corresponding to the acquired file identifiers, and issues the list to the client. In such a way, the user can download selected files by using the client.

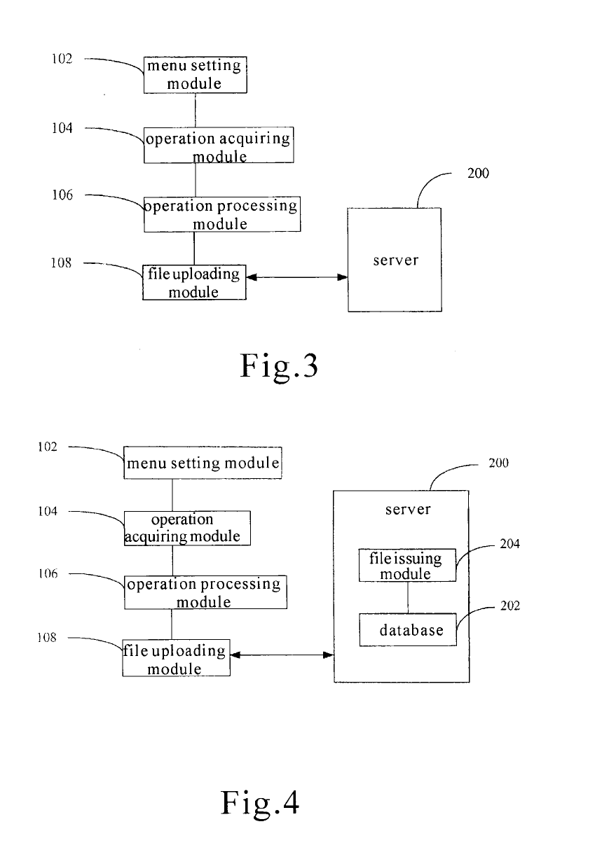

As shown in FIG. 3, in an embodiment, a file management system includes a menu setting module 102, an operation acquiring module 104, an operation processing module 106 and a file uploading module 108, wherein:

The menu setting module 102 is used for setting the cloud copy buttons in the right-click menus of the files and/or file folders.

In an embodiment, the menu setting module 102 can set the cloud copy button in the right-click menu of the file and/or file folder by amending a corresponding sub-key in the registry. Specifically, the menu setting module 102 can create the sub-key corresponding to the cloud copy button in the registry, and set the command corresponding to the sub-key as the file-sending command of the preset client.

As the cloud copy button corresponds to the file-sending command of the preset client, the file-sending command is executed when the cloud copy button is clicked. As shown in FIG. 2, the “QQCloudCopy” button set by the menu setting module 102 is located at a middle location of the right-click menu of the file/file folder. The selected files/file folders are uploaded onto the server 200 when the cloud copy buttons are clicked.

The operation acquiring module 104 is used for acquiring the clicking operations on the cloud copy buttons by the user.

In an embodiment, when the user selects a file or a file folder, opens the right-click menu and clicks the cloud copy button in the right-click menu, the operation acquiring module 104 acquires the clicking operation on the cloud copy button by the user.

The operation processing module 106 is used for invoking the file-sending commands corresponding to the cloud copy buttons in accordance with the clicking operations.

The file uploading module 108 is used for executing the file-sending commands to upload the files and/or file folders selected by the user to the server 200.

Specifically, the file uploading module 108 is used for executing the file-sending commands of the preset client, and uploading the files and/or file folders selected by the user onto the server 200 by using a network communication protocol via a client invoking procedure. Furthermore, the file uploading module 108 can upload the files and/or file folders selected by the user onto the server by using “http” protocol in the manner of “post”.

The preset client can be an Instant Messaging client, a Computer Keeper client, or any other application client capable of uploading files. The file uploading module 108 can be set in the clients, and the file uploading module 108 executes the preset file-sending commands and uploads the files and/or file folders selected by the user to the server 200 from the clients. In an embodiment, the file uploading module 108 is further used for acquiring the user identifier and the file identifiers of the selected files or file folders, and correspondingly sending the user identifiers and the file identifiers to the server 200.

Furthermore, the file uploading module 108 is used for acquiring the user login information. If the user login information is acquired, then the user identifier is acquired in accordance with the user login information. If the user login information is not acquired, then a login block is popped out, the input user login information is acquired by the login block, and the user identifier is acquired in accordance with the input user login information.

The user identifier can be an account number for login in the client by the user, a number for uniquely identifying the user assigned for the user by the client, and so on. If the file uploading module 108 cannot acquire the user identifier of the user currently logining in the client, it means that the current user does not login in the client, and the user identifier can be acquired after the user is reminded of logining in the client.

In an embodiment, as shown in FIG. 4, the server 200 includes a database 202 for acquiring the user identifier and the file identifiers and storing the user identifier in association with the file identifiers. That is, the database 202 stores the correspondence relation between the user identifier and the file identifiers. Specifically, the file identifiers include file names, file sizes, file Hash values and so on.

Furthermore, the uploaded files can be stored in the manner of cloud storage. That is, the uploaded files can be stored by using cluster applications, grid technology, or scattered file systems. Many different kinds of storage devices in a network can assemble together and cooperate by means of application software, to jointly provide data storage and service access functions to external.

In an embodiment, the server 200 also includes a verifying module (not shown in the figure) for verifying the files/file folders selected by the user in accordance with the file Hash values to determine whether there are corresponding files in the database 202 before uploading the files onto the server 200. If there are corresponding files in the database 202, it is unnecessary to upload the files already existing in the database 202, and reminder information that reminds the user of the existence of the files is returned.

In another embodiment, as shown in FIG. 4, the server 200 further includes a file issuing module 204 for acquiring the user identifier and the file identifiers associated with the user identifier, and issuing the file list corresponding to the acquired file identifiers to the client. In the embodiment, after the files are successfully uploaded, the client can download the files corresponding to the user identifier from the server 200 in accordance with the user identifier, and thus file sharing is implemented.

Specifically, the user identifier can be submitted to the server 200 by the client. The file issuing module 204 of the server 200 is used for acquiring the file identifiers associated with the user identifier stored in the database 202 in accordance with the user identifier, forming the list by using the files corresponding to the acquired file identifiers, and issuing the list to the client. In such a way, the user can download the selected files by the client.

In the above file management method and system, by setting the cloud copy buttons in the right-click menus of the file and/or file folders, the user can directly click the cloud copy button in the right-click menu of a file or a file folder when selecting the file/file folder; when the clicking operation on the cloud copy button by the user is acquired, the file-sending command corresponding to the cloud copy button can be invoked and executed and the file and/or file folder selected by the user can be directly uploaded onto the server. In such a way, it is unnecessary to set the entrance for file uploading on the client or the network station, and the user is not required to select files to be uploaded via the client or the network station. So user operations are saved and it is more convenient for the user to manage files via the network.

Furthermore, after the clicking operations on the cloud copy buttons are acquired, the user identifier is submitted by the client, and the server stores the user identifier in association with the file identifiers, the files can be effectively managed by using user identifier. It is convenient to download the files stored on the network by using other platforms, and file sharing is implemented among different platforms.

The person skilled in the art will understand that all or a part of steps in the above embodiment can be implemented by a hardware instructed by a computer program, wherein the program can be stored in a computer readable storage medium. When the program is executed, steps of respective methods in the above embodiments can be implemented. The storage medium can be a magnetic disk, an optical disk, a Read Only Memory (ROM), a Random Access Memory (RAM) and so on.

The above embodiments are merely several implementations of the invention. and they are relatively specific and detailed. However, the above embodiments should not be interpreted as limit to the scopes of the invention. It should be pointed out that variations and improvements can be made by the person skilled in the art to the invention without departing the spirit of the invention. Therefore, the protection scopes of the invention shall be merely limited by the accompany claims.

What is claimed is:

1. A file management method comprising the steps of:
acquiring clicking operations on cloud copy buttons set in right-click menus of files or file folders;
invoking file-sending commands corresponding to the cloud copy buttons in accordance with the clicking operations;
executing the file-sending commands to upload files and/or file folders selected by a user to a server.

2. The file management method of claim 1, wherein before the step of acquiring the clicking operations on the cloud copy buttons set in the right-click menus of the files or file folders, the method further comprises:
creating sub-keys corresponding to the cloud copy buttons in a registry, and setting commands corresponding to the sub-keys as the file-sending commands of a preset client.

3. The file management method of claim 2, wherein the step of executing the file-sending commands to upload the files and/or file folders selected by the user onto the server comprises:
executing the file-sending commands of the preset client, and uploading the files and/or file folders selected by the user onto the server from the client by using a network communication protocol via a client invoking procedure.

4. The file management method of claim 3, further comprising:
acquiring file identifiers of the selected files or file folders and a user identifier by the client, and correspondingly sending the user identifier and the file identifiers to the server.

5. The file management method of claim 4, wherein the step of acquiring the user identifier by the client comprises:
acquiring user login information by the client;
if the user login information is acquired, then acquiring the user identifier in accordance with the user login information;
if the user login information is not acquired, then popping out a login block, acquiring the input user login information by the login block, and acquiring the user identifier in accordance with the input user login information.

6. The file management method of claim 4, wherein the file identifiers include file names, file sizes, and file Hash values, and the file management method further comprises:
the server storing the user identifier in association with its corresponding file identifiers.

7. The file management method of claim 6, further comprising:
the server acquiring the user identifier submitted by the client;
acquiring the file identifiers stored in association with the user identifier;
issuing a file list corresponding to the acquired file identifiers to the client.

8. A file management system comprising:
an operation acquiring module for acquiring clicking operations on cloud copy buttons set in right-click menus of files or file folders;
an operation processing module for invoking file-sending commands corresponding to the cloud copy buttons in accordance with the clicking operations;
a file uploading module for executing the file-sending commands to upload files and/or file folders selected by a user to a server.

9. The file management system of claim 8, further comprising:
a menu setting module for creating sub-keys corresponding to the cloud copy buttons in a registry, and setting commands corresponding to the sub-keys as the file-sending commands of a preset client.

10. The file management system of claim 9, wherein the file uploading module is used for executing the file-sending commands of the preset client, and uploading the files and/or file folders selected by the user onto the server from the client by using a network communication protocol via a client invoking procedure.

11. The file management system of claim 10, wherein the file uploading module is further used for acquiring file identifiers of the selected files or file folders and a user identifier, and correspondingly sending the user identifier and the file identifiers to the server.

12. The file management system of claim 10, wherein the file uploading module is used for:
acquiring user login information;
if the user login information is acquired, then acquiring the user identifier in accordance with the user login information;
if the user login information is not acquired, then popping out a login block, acquiring the input user login information by the login block, and acquiring the user identifier in accordance with the input user login information.

13. The file management system of claim 10, wherein the file identifiers include file names, file sizes, and file Hash values; and
the file management system further comprises a server, the server including:
a database for storing the user identifier in association with its corresponding file identifiers.

14. The file management system of claim 13, wherein the server further comprises:
a file issuing module for acquiring the user identifier submitted by the client, acquiring the file identifiers stored in association with the user identifier in the database, issuing a file list corresponding to the acquired file identifiers to the client.

15. One or more storage mediums containing computer executable instructions for executing a file management method, the method comprising the steps of:
acquiring clicking operations on cloud copy buttons set in right-click menus of files or file folders;
invoking file-sending commands corresponding to the cloud copy buttons in accordance with the clicking operations;
executing the file-sending commands to upload files and/or file folders selected by a user onto a server.

16. The storage mediums of claim 15, wherein before the step of acquiring the clicking operations on the cloud copy buttons set in the right-click menus of the files or file folders, the method further comprising:
creating sub-keys corresponding to the cloud copy buttons in a registry, and setting commands corresponding to the sub-keys as the file-sending commands of a preset client.

17. The storage mediums of claim 16, wherein the step of executing the file-sending commands to upload the files and/or file folders selected by the user to the server comprises:
executing the file-sending commands of the preset client, and uploading the files and/or file folders selected by the user onto the server from the client by using a network communication protocol via a client invoking procedure.

18. The storage mediums of claim 17, wherein the method further comprises:
acquiring file identifiers of the selected files or file folders and a user identifier by the client, and correspondingly sending the user identifier and the file identifiers to the server.

19. The storage mediums of claim 18, wherein the step of acquiring the user identifier by the client comprises:
acquiring user login information by the client;
if the user login information is acquired, then acquiring the user identifier in accordance with the user login information;
if the user login information is not acquired, then popping out a login block, acquiring the input user login information by the login block, and acquiring the user identifier in accordance with the input user login information.
